(19) United States
(12) Patent Application Publication
(10) Pub. No.: US 2013/0117279 A1
(43) Pub. Date: May 9, 2013

(54) Systems and Methods for Dynamic Conversation Management

(71) Applicant: IdeaString, LLC, Atlanta, GA (US)

(72) Inventors: Charles Jacob Massey, Roswell, GA (US); Genevieve Tondi Bos, Atlanta, GA (US)

(73) Assignee: IDEASTRING, LLC, Atlanta, GA (US)

(21) Appl. No.: 13/659,904

(22) Filed: Oct. 24, 2012

Related U.S. Application Data
(60) Provisional application No. 61/550,785, filed on Oct. 24, 2011.

(51) Int. Cl. G06F 17/30

(52) U.S. Cl. CPC G06F 17/30345
USPC 707/748

(57) ABSTRACT

Certain embodiments herein relate to generating profiles associated with users and comparing the profiles to determine which contributions, such as conversations, in which the users should participate. User profiles may be based on a user's historical activities, such as browsing certain web pages or generating ideas that may be shared by others, as well as a user's personality profile. Each profile may be scored based at least in part on the user's historical activities and personality profile, as examples, to identify other users who should be invited to participate in conversations with the user.

### TECHNICAL FIELD

Embodiments of this disclosure relate generally to the dissemination of information over a computer network, and more particularly, to associating information disseminated over a network based on characteristics of the information.

### BACKGROUND

A wealth of information may be generated by individuals across various social media technologies, websites, or other information resources. Existing systems, while having access to such information, may not leverage the collective knowledge of these individuals to enhance, for example, thought processes and the resolution of problems that may be shared among the individuals, corporations, or other entities.

### BRIEF DESCRIPTION OF THE DISCLOSURE

Some or all of the above needs and/or problems may be addressed by certain embodiments of the disclosure. Certain embodiments may include systems and methods for integrating alarm processing and presentation of alarms for a power generation system. According to one embodiment, there is disclosed a method for generating, by a management server comprising one or more computing devices, one or more profiles associated with one or more respective users, wherein the one or more profiles comprise a respective score; receiving, at the management server, a contribution to a conversation from a user of the one or more respective users; identifying, by the management server, at least a portion of the one or more respective users for participation in the conversation based at least in part on the contribution; in response to the identification, sending a request from the management server to the at least a portion to participate in the conversation; receiving, at the management server, one or more respective contributions from at least a portion of the one or more respective users; and updating, by the management server, the respective score associated with a profile of the user based at least in part on the one or more respective contributions.

According to another embodiment, there is disclosed including at least one memory that stores computer-executable instructions and at least one processor configured to generate one or more profiles associated with one or more respective users, wherein the one or more profiles comprise a respective score; receive a contribution to a conversation from a user of the one or more respective users; identify at least a portion of the one or more respective users for participation in the conversation based at least in part on the contribution; in response to the identification, send a request to the at least a portion to participate in the conversation; receive one or more respective contributions from at least a portion of the one or more respective users; and update the respective score associated with a profile of the user based at least in part on the one or more respective contributions.

Other embodiments, systems, methods, apparatuses, aspects, and features of the disclosure will become apparent to those skilled in the art from the following detailed description, the accompanying drawings, and the appended claims.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a schematic diagram of an example computing environment for facilitating the processes described herein, according to an embodiment of the disclosure.

FIG. 2 illustrates an example computing environment of a device for implementing or facilitating the association of information as described herein, according to an embodiment of the disclosure.

FIG. 3 illustrates a flow diagram of an example process for generating a user account that includes innovation perspective profile information and personality preference profile information, according to an embodiment of the disclosure.

FIG. 4 illustrates a flow chart of an example process for inviting certain users to participate in a conversation based on prior contributions from other users, according to an embodiment of the disclosure.

FIG. 5 illustrates a flow diagram of an example process that facilitates the configuration of a user's profile by enabling the user to select certain other users to participate in conversations with the user based on the innovation perspective profile and personality preference profile of the other users, according to an embodiment of the disclosure.

FIG. 6 illustrates an example graphical user interface for a user to create, submit, and view conversations, according to an embodiment of the disclosure.

FIG. 7 illustrates an example dashboard representation of ideas generated by various users, according to an embodiment of the disclosure.

FIG. 8 illustrates an example dashboard representation of a user's innovation perspective, including points earned for idea generation, according to an embodiment of the disclosure.

FIG. 9 illustrates an example display diagram depicting nodes representing conversations that have been associated with one another, according to an embodiment of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers refer to like elements throughout.

### DETAILED DESCRIPTION

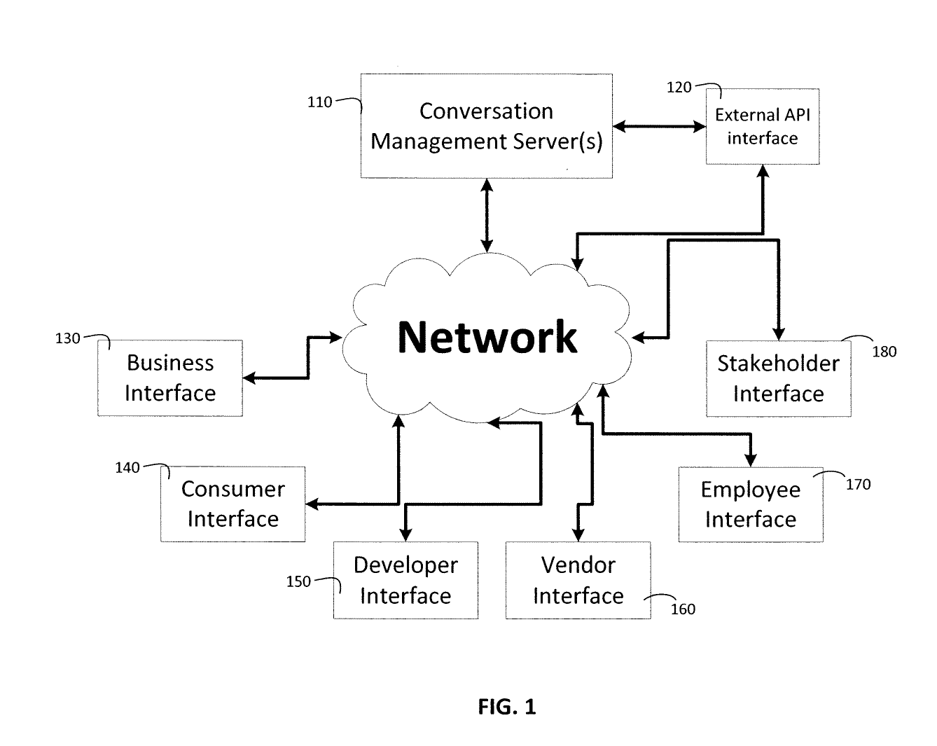

FIG. 1 a schematic diagram of an example computing environment for facilitating the processes described herein, according to an embodiment of the disclosure. As shown in FIG. 1, a conversation management server or device 110 may communicate with various devices over one or more networks 105. Such devices may provide an interface for various types of users to interface with the conversation management server 110. Non-limiting examples of such interfaces may include a business interface 130, a consumer interface 140, a developer interface 150, a vendor interface 160, an employee interface 170, and a stakeholder interface 180. Other embodiments may involve a single interface that may be utilized by one or more users to interface with the conversation management module 110.

An external application programming interface (API) 120 may facilitate communication between the conversation management server 110, the interfaces shown in FIG. 1, or other external data sources available via the web or an internal network. The external data sources may include various types of systems, including any social media sites, internal HR, CRM, ERP, SharePoint, Jive, or other systems that may or may not be internal to an organization.

The conversation management server 110 may include a collection of devices or servers, such as web servers, database servers, and application servers that may receive inputs from various other devices or interfaces and utilize information associated with the inputs to present conversations to users. In one embodiment, such presentation may include conversations that a user's historical behavior, activities, and/or preferences indicate that the user has a particular interest in the conversations (e.g., complementary conversations). Additionally and/or alternatively, a user's presentation of conversations may include conversations that differ from the user's historical behavior, activities, and/or preferences (e.g., opposing conversations). By identifying different or opposing interests, certain embodiments herein may enhance user discussion or conversations between users by presenting differing viewpoints. Certain embodiments herein may also enhance conversations between users by associating or sharing ideas from users that have similar backgrounds or interests.

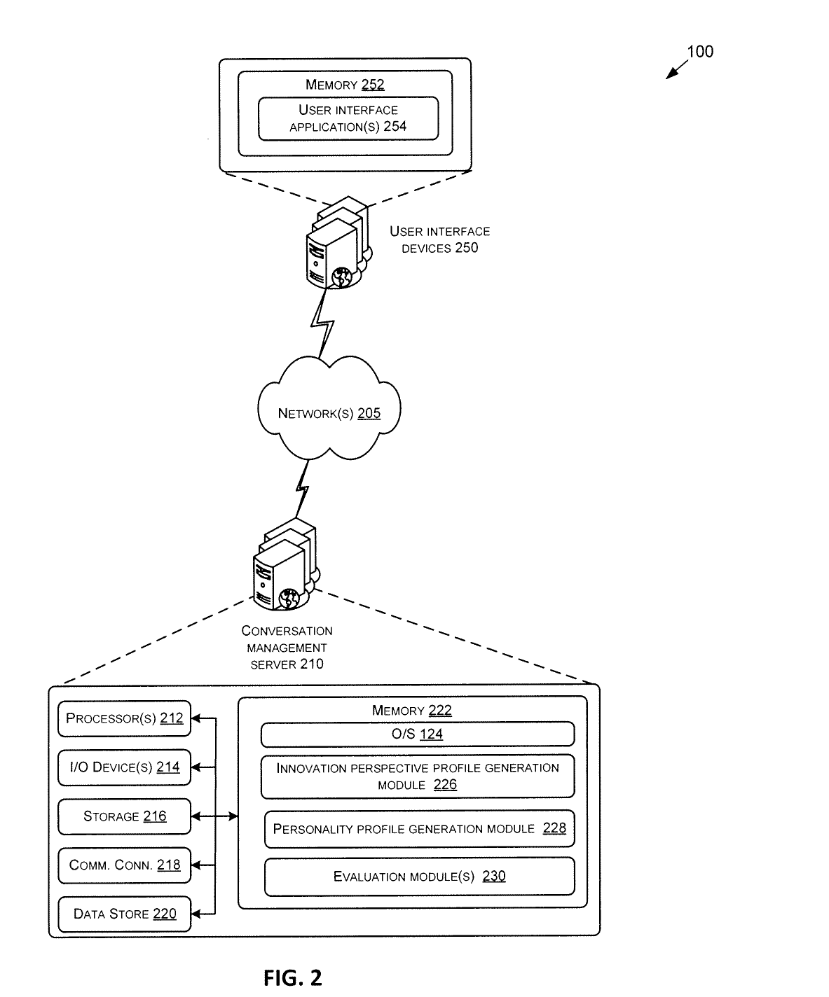

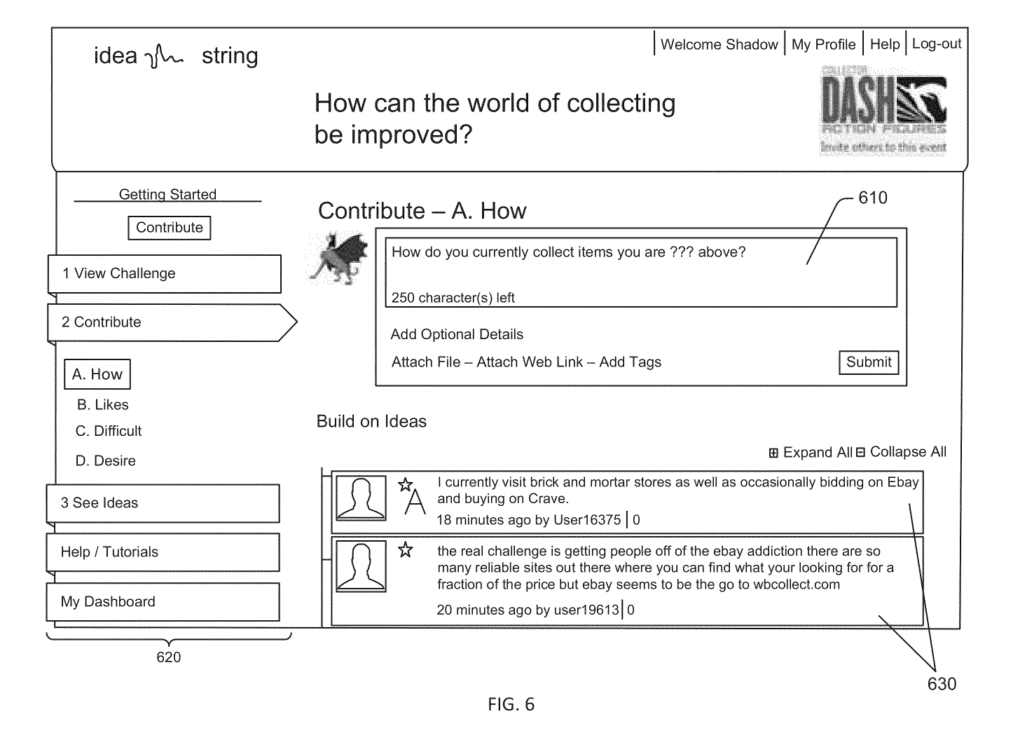

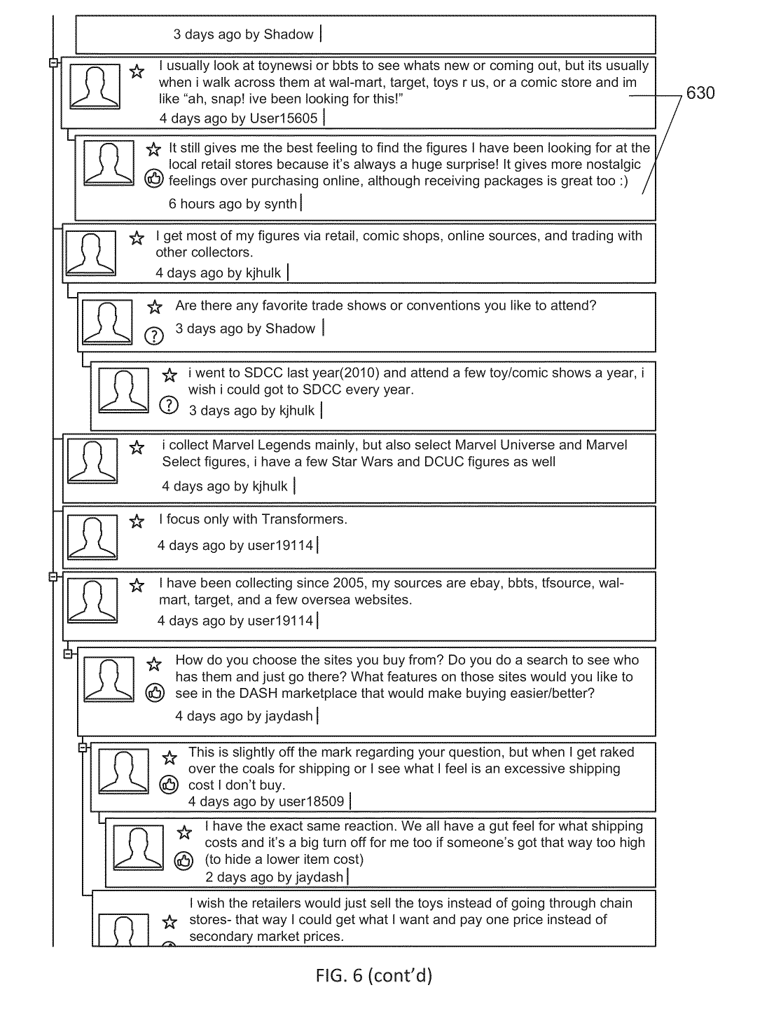

A user's behavior or preferences may be identified by the conversation management module 110 in a number of ways. For example, the conversation management module 110 may (e.g., via software and/or program modules described in FIG. 2) access information associated with messages or conversations submitted on a user interface (such as the user interface shown in FIG. 6) provided by the conversation management module 110. User preferences or behavior may also be identified by importing data form various sources, such as LinkedIn, Facebook, Twitter, Photobucket, Flickr, Wikipedia, or other social networking sites. As another example, the conversation management module may receive and analyze user-supplied content received from the interfaces shown in FIG. 1 over the one or more networks 105 to determine user preferences and behavior. As will be described in greater detail below, such preferences and/or behavior may be utilized to identify conversations in which a user may be presented an opportunity to participate.

As used herein, the business interface 130 may be defined as an interface that allows a business to communicate with the conversation management server 110 via a networking protocol that may be implemented by the external API interface 120. Example networking protocols may include, but are not limited to, Hypertext Transfer Protocol (HTTP), Transmission Control Protocol/Internet Protocol (TCP/IP), socket-based protocols such as the WebSocket protocol, Short Message Service (SMS) text messaging for supporting communication with a mobile device, Simple Mail Transfer Protocol (SMTP) for transmitting messages via electronic mail, or other message formats and/or rules for exchanging information between computing devices to support communication between web-based program code and client-server-based program code, as non-limiting examples.

The consumer interface 140 may be defined as an interface that allows external consumers to communicate with the conversation management server 110 via a networking protocol.

The developer interface 150 may be defined as an interface that allows developers to communicate with the conversation management server 110 via a networking protocol. The communication may occur via our a web Service API, JavaScript API, through implementation by other programming languages, or other techniques of importing and/or using objects or functionality provided by the conversation management server 110, at least some of which are described in FIG. 2.

The vendor interface 160 may be defined as an interface for company vendors to communicate with the conversation management server 110 via a networking protocol.

The employee interface 170 may be defined as an interface for employees to communicate with the conversation management server 110 via a networking protocol.

The stakeholder interface 180 may be defined as an interface for stakeholders to communicate with the conversation management server 210 via a networking protocol.

As described above, the interfaces in FIG. 1 are non-limiting. Various other interfaces associated with different types and/or numbers of users may exist to facilitate communication between these users and the conversation management server 110.

The one or more networks 105 may be defined as a communication layer that allows data to travel between the various interfaces. The one or more networks 105 may include any number of wired or wireless networks that can enable various computing devices in the example computing environment 100 to communicate with one another. In some embodiments, other networks, intranets, or combinations of different types of networks may be used including, but not limited to, the Internet, intranets, cable networks, cellular networks, landline-based networks, radio networks, satellite networks, wireless fidelity (WiFi) networks, WiFi Direct networks, Bluetooth® networks, or other communication mediums connecting multiple computing devices to one another. Other embodiments may not involve a network and may, for example, provide features on a single device or on devices that are directly connected to one another, e.g., a device providing the employee interface 170 may be directly connected to the conversation management server 110. In other embodiments, the network may include a self-contained computer or a direct leased line.

FIG. 2 illustrates an example computing environment of a device for implementing or facilitating the association of information as described herein, according to an embodiment of the disclosure. The devices in FIG. 2 may include one or more processors configured to communicate with one or more memory devices and various other components or devices. For example, the conversation management server 110 may include one or more processors 212 that are configured to communicate with one or more memory or memory devices 222, one or more input/output (I/O) devices 214, storage 216, one or more communication connections 218, and one or more data stores 220. The processor 212 may be implemented as appropriate in hardware, software, firmware, or a combination thereof.

The storage 216 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 222 may include multiple different types of memory, such as static random access memory (SRAM), dynamic random access memory (DRAM), or ROM.

The memory 222 and the storage 216, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data.

The one or more communication connections 218 may allow the conversation management server 210 to communicate with other devices, such as the user interface devices 250, databases, user terminals, and various other devices that may exist on the one or more networks 205.

The I/O devices 214 may enable a user to interact with the conversation management server 210 to perform various functions. The I/O devices 214 may include, but are not limited to, a keyboard, a mouse, a pen, a voice input device, a touch input device, a display, a camera or imaging device, speakers, or a printer.

The one or more data stores 220 may store lists, arrays, databases, flat files, etc. In some implementations, the data stores 120 may be stored in memory external to the conversation management server 210 but may be accessible via the one or more networks 205, such as with a cloud storage service. The data stores 120 may store information that may facilitate the processes described herein.

The memory 222 may also store an operating system (O/S) 124 and various software applications and/or modules that may implement the processes described herein. Example modules may include, but are not limited to, an innovation perspective profile generation module 226, which may facilitate the generation of innovation perspective profiles for users as described herein, a personality preference profile generation module 228, which may facilitate the generation of personality preference profiles for users as described herein, and one or more evaluation modules 230. Each of these modules may be implemented as individual modules that provide specific functionality associated with implementing collaborative bidding. Alternatively, one or more of the modules may perform all or at least some of the functionality associated with the other modules.

The evaluation modules 230 may perform a number of functions, including comparing profiles among users to identify profiles that are complementary or opposing, as described herein. Evaluation of profiles may be performed to determine which users may be invited to participate in certain conversations. The evaluation modules 230 may further access, identify, generate, and determine one or more scores associated with each of the profiles. In examples in which profiles the same or similar score, the evaluation modules 230 may determine that the users associated with such profiles should be invited to participate in conversations generated by users having similar profiles. In example in which the profiles have different scores, or may assess users to belong to different personality quadrants, the evaluation modules may determine that users associated with certain profiles, e.g., opposing profiles, should participate in the conversation. In another example, the evaluation modules 230 may determine that users whose innovation perspective profiles are dominated by their generation of ideas (e.g., top idea generators as will be discussed in greater detail below) should participate in the same conversations. Similarly, users whose innovation profiles are dominated by the users' desire to view various web pages, for example, more so than generating ideas, may be identified are users who should participate in the same conversations. Numerous other examples may exist in other embodiments.

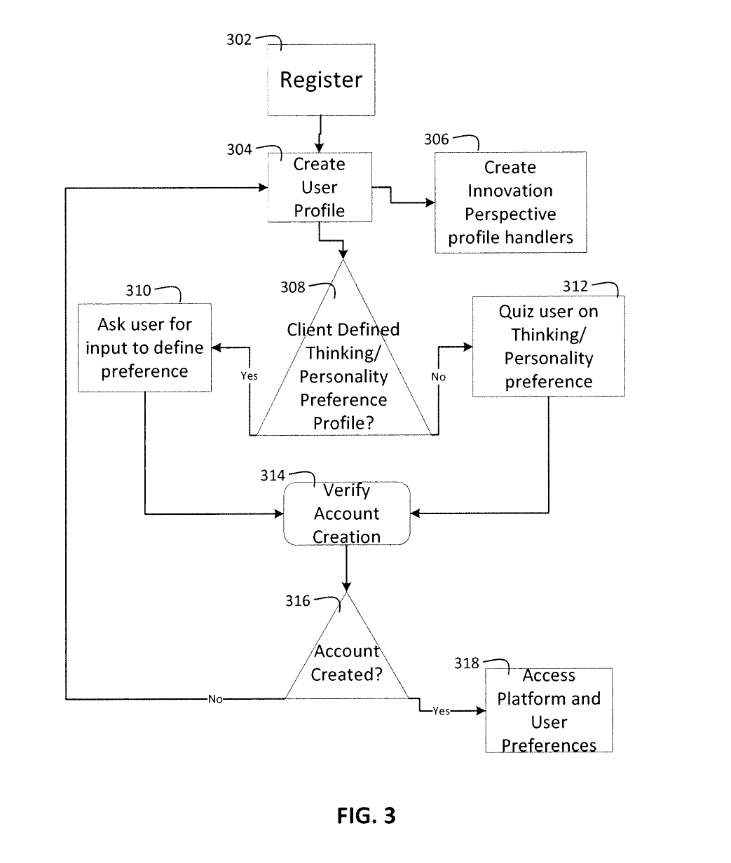

FIG. 3 depicts a flow diagram of an example process for generating a user account that includes innovation perspective profile information and personality preference profile information, according to an embodiment of the disclosure. As used herein, the personality preference profile may also be referred to as the thinking or personality preference profile. At block 302, a user may register to leverage the association of conversations or other information as described herein. Such registration may include the user providing generic information, such as, but not limited to, first name, last name, electronic mail address, password, age, an indication that the user has accepted terms and conditions associated with utilizing the conversation management server, as well as imported information from external sources such as LinkedIn, Facebook, and Twitter, e.g., imported via the external API interface 120.

At block 304, a user profile may be created. Such creation may occur after a user has entered required information at the time of registration, in one embodiment. The generated user profile may be stored into a data store, database, or other storage mechanism.

At block 306, innovation perspective profile handlers may be generated. The innovation perspective profile handlers may utilize one or more algorithms to generate a user's innovation perspective profile. Various categories may exist within a user's perspective profile. A user may belong to one or more of these categories based on various criteria, including the user's historical performance or behavior in association with viewing or interacting with conversations or other information, in one embodiment. Example categories for the innovation perspective profile may include an Innovation Scout, Innovation Supporter, Innovation Top Idea Generator, or Innovation Originator. Different names or identifications of categories may exist in other embodiments.

An Innovation Scout may describe users who spend the majority of their time (e.g., 51% or more) browsing or looking for conversations to join. An Innovation Supporter may describe users who interact with conversations by, for example, marking favorite, following by clicking on the stars or other indicators that enable the users to view more information associated with conversations (e.g., see Exhibit 1, label A).

An Innovation Top Idea Generator may described users who have been identified as generated relatively more ideas (“top idea award”), and/or more significant awards (“big idea award”) (e.g., as determined by a user having permission to judge and score ideas in one embodiment). The top idea award may be determined by the conversation management module 110 based on a total number of earned points (e.g., based on the number of ideas or conversations the idea has generated (e.g., child ideas)), the number of favorite idea markings it has gotten, the number of big idea awards it has received, according to one embodiment, and partial credit for any awards given to child ideas or conversations.

An Innovation Originator may describe users who initially conceive of ideas or conversations. For instance, users who spend 50% of their time navigating and reading contributions or conversations may have such activity impact their Innovation Scout score and subsequently influence the conversations, events, and/or sessions to which they will be invited. In the present example, the user may be considered a dominant Scout. If the user marks favorites of other ideas or conversations, such activity may increase the user's Innovation Supporter Score. A user's Innovation Supporter score may also be influenced by the amount of interaction the user contributed to an idea.

Certain factors for a user, such as number of years the user or employee has been employed, the domain expertise of the user, the job function of the user, the industry to which the user belongs, the user' title, the user's age, the company for which the user works, etc., may affect the weighting of the Innovation Scout score, or other scores, on a user's overall Innovation Perspective. According to one example, if a user is awarded a top idea award based on the scoring rules of implemented by the conversation management server 110, the top idea award may substantially influence the ideas or conversations to which the user is invited. For example, if the user creates ideas that win 1000 points or a number of points higher than other users, the user may be declared a top idea award winner. The award may significantly influence both the ideas and conversations the user is invited to, as well as influence the overall system level algorithm by evaluating the users' demographic information then altering the weighting of other users that match this profile. For example, if the conversation management module 110 identifies a conversation involving engineers with less than five years or work experience, the conversation management module 110 may determine which users' innovation perspective profiles indicate that they have more than a certain number of years or work experience (e.g., ten years of work experience) to, for example, include more experienced employees into the discussion. As another example, the conversation management module 110 may also identify other engineers who also have five years of work experience but who have different domain expertise. According to this example, the conversation management module 110 may have identified certain keywords in the text of the conversations that matched a certain domain and, based on the matched keyword, may determine that engineers or other users belonging to matched domain should be included in the conversation.

At block 308, a Client Defined Thinking/Personality Preference Profile may be defined as a decision tree within the conversation management server 110 that allows for a user to have a personality assessment tool of choice custom loaded into the system, and is defined as Birkman, Hermann Brain Dominance Instrument (HBDI), Myers Brigg, or any other talent assessment/personality assessment tool that the client may be able to define in the conversation management server 110. This is also a decision point to see if the user's data has previously been loaded via the external API interface 120 from an external source. If data has been loaded from one of the external API interfaces 120, then the data may have an impact on the users' stored innovation perspective and thinking or personality perspective such that based on a user's job function, title, company, geographic location, etc., the user's comments and contributions may be weighted complementary to the overall flow of ideas and/or conversations. For example, if a conversation is taking place between many mid-level managers, that have engineering backgrounds, the conversation management server 110 may automatically invite C-Level executives having marketing or sales backgrounds. The conversation management server 110 may also determine, based on sentiment, to invite complementary thought processes to the conversation to ensure it remains an engineering conversation.

At block 312, a user may be tested on the user's thinking or personality preferences to generate a personality preference profile. Such a test or quiz on a user's thinking or personality preference may include a series of methods and/or functions that allow the integration of short quizzes or questionnaires that determine the user's thinking or personality preference. For example, when users create their profile, a series of questions may be presented to them that match the thinking or personality assessment of various tools, such as HBDI. Such questions may provide a scoring mechanism that may be used to categorize users. Users may be asked questions that fit into a series of four categories. In an embodiment in which HBDI is used, it may be quadrants A, B, C, and D. The A quadrant (or Blue quadrant) may identify users as Logical, Analyzer, Mathematical, Technical, and Problem Solver. The B quadrant (or green quadrant) may identify users as Controlled, Conservative, Planner, Organizational, and Administrative. The C quadrant (or the red quadrant) may identify users as Interpersonal, Emotional, Musical, Spiritual, and Talker. The D quadrant (or the yellow quadrant) may identify users as Imaginative, Synthesizer, Artistic, Holistic, and Conceptualizer. Based on a user's response to questions, the user may be classified into the various quadrants or categories. For example, an HBDI score of 33 or less may signify that a user has avoidance properties towards a given quadrant. A score between 34 and 66 may indicate a secondary preference. A score above 67 in a given quadrant may show a preference towards the quadrant in question, and a score over 100 may show a very strong preference towards a quadrant, and will be given a bonus score of +1 into that thinking pattern.

In some embodiments, a user may be prompted by the conversation management module 110 for input to define a personality preference or profile, at block 310. According to these embodiments, the user may input data already known from previous personality assessments. Such information may be input into a template or other form designed to capture such information. For example, if a user already knows their thinking or personality profile, the user may enter it into the template or into a user interface provided by the conversation management module 110. An example would include, after a user has registered with the system, the user may access their user preferences. In the case of a company using HBDI, four boxes may be provided for the user to enter the user's HBDI scores. Box 1 may be the score for the A quadrant, in this case 75. Box 2 may be the score for the B quadrant, in this case 101. Box 3 may be the score for the C quadrant, in this case 31, and Box 4 may be the score for the D quadrant, in this case 55. This may show a dominance of a Controlled, Conservative Analyzer, who has the ability to see the larger picture and who avoids emotional attachment. This may influence the ideas and conversations to which the user is invited to participate, by looking at existing conversations that have higher participation by emotionally (quadrant C) based individuals and/or participants.

At block 314, a user's account creation may be verified. Whether the generated account has been stored may also be verified. If the account was created, at block 316, a determination may be made as to whether the account was successfully created. If the account was not successfully created, then the user profile generation process may be repeated (e.g., block 304). If the user account was successfully created, a user may be granted access to the user's personal preferences and the conversation management server 110 may be granted. Such access may be referred to herein as access to the platform and user preferences.

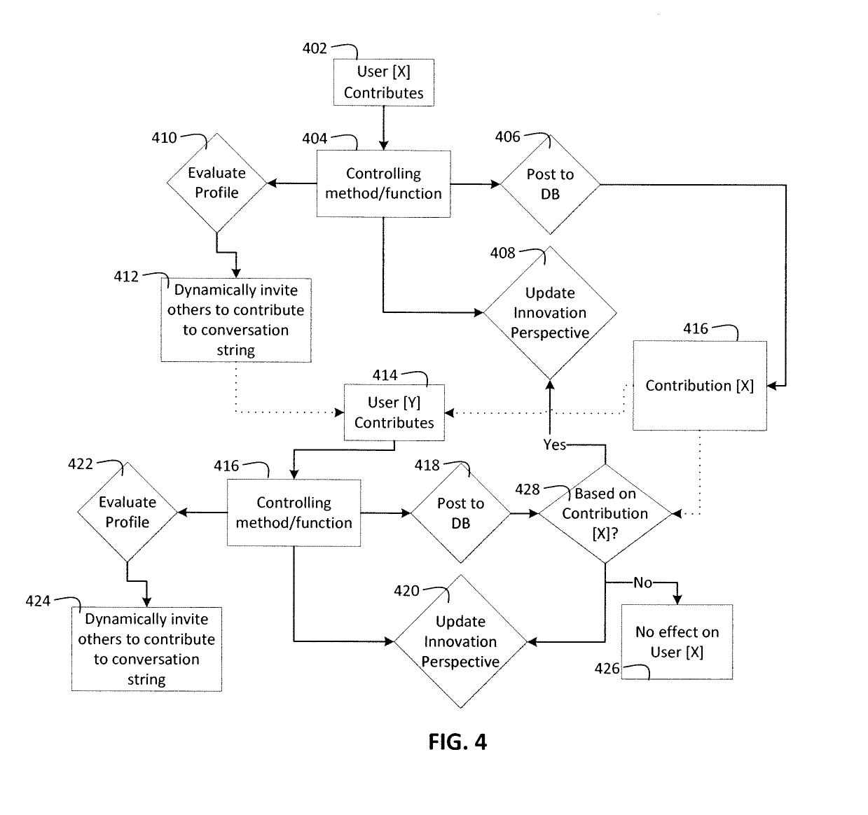

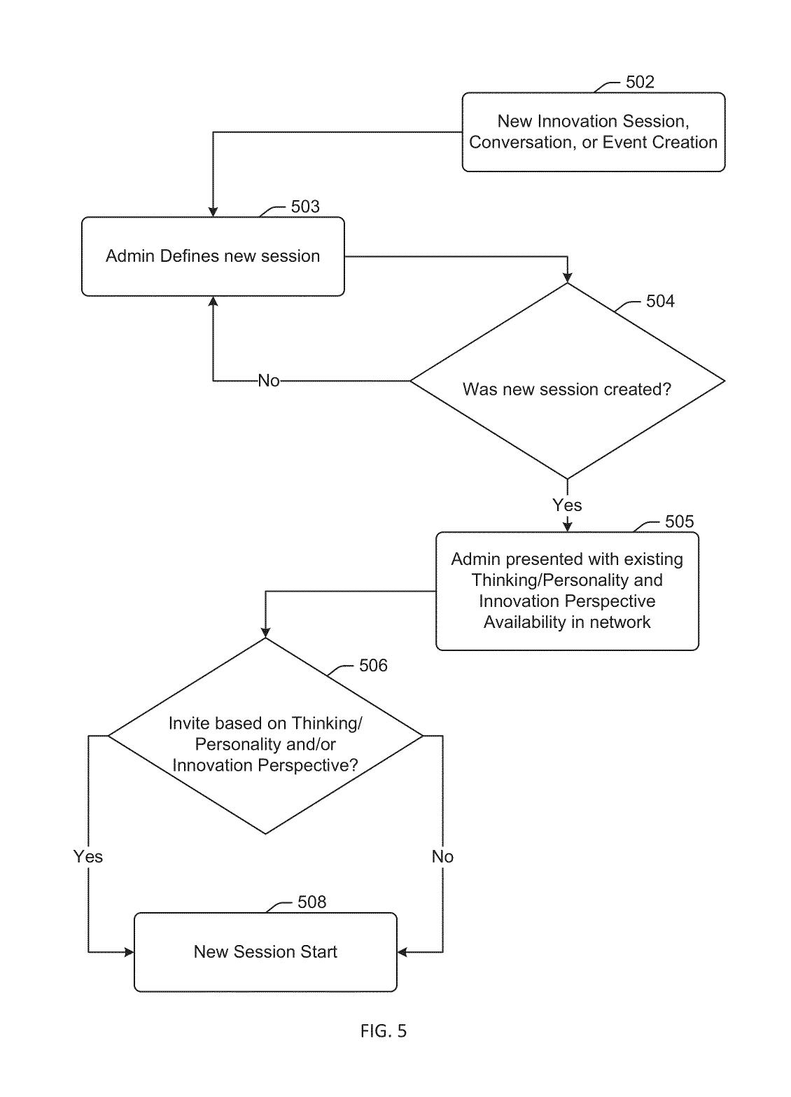

FIG. 4 depicts a flow chart of an example process for inviting certain users to participate in a conversation based on prior contributions from other users, according to an embodiment of the disclosure. At block 402, a contribution from a user (e.g., User X) may be received. According to the present embodiment, User X may have been granted access to the conversation management server 110, e.g., via successful account creation as described in FIG. 3. The user contribution received at block 402 may include, but is not limited to, the conversation management server 110 receiving profile data, or content in the form of data that has been scraped from an external API interface, e.g., the external API interface 120 in FIG. 1, or contributed in the form of a part of a conversation, such as a micro blogging element or a more detailed element of data. These contributions may also take the form of digital attachments (i.e. documents, images, drawings, etc.), web links (i.e. any external HTML link that imports content from another website or webpage), or text input. The method that a user uses to contribute such information, e.g., whether publicly or anonymously, may have an impact on the user's innovation perspective score.

At block 404, contributions from a user may be received and stored in a data store, such as a database. Additionally, a user's profile may be evaluated to determine the user's innovation perspective and thinking or personality perspective scores and the user's innovation perspective score and/or personality perspective score may be updated. For example, based on the user's behavior defined in creating the innovation perspective profile handlers (e.g., block 306 in FIG. 3), the innovation perspective may be updated to reflect the user's profile activity, which may affect the weighting of the user's contributions to conversations related to the activity. In one example, a user's activity or originating an idea may have an impact on the user's innovation perspective by raising the user's origination score. In such an instance, other user scores, such as the scout score, may decrease as a result of the user's origination score increasing. Such a relationship between scores may emphasize a relatively higher importance of some activities or scores relative to other activity or scores based on a user's actions. If, for example, a user has a dominant origination score prior to an increase in origination score, the weighting may be smaller in relation to other activities to maintain a holistic approach to the innovation perspective.

At block 406, the user's contribution may be stored in a database or other data store mechanism. Such a data store mechanism may be accessible to the conversation management server 110 such that the server 110 may access, analyze, and update information based on the contributions.

At block 408, a user's innovation perspective may be updated based on the contribution made by the user. Such an update may include updating both the user's customer innovation perspective score, as well as the global community's innovation perspective score.

At block 410, profiles (e.g., the innovation perspective profile and the personality perspective profile) of a user who made a contribution may be evaluated in part by accessing scores associated with each of the profiles. Such a process may be comparative in the way that it may analyze the overall perspective in relation to both the innovation perspective and the personality perspective as defined in block 306, 310, and 312, in one embodiment.

At block 412, other users may be dynamically invited to contribute to a conversation string, e.g., a conversation string started by a user at block 402. Users may be invited to contribute to a conversation based on a user's contribution and updated innovation perspective score (e.g., at block 408). If for instance, User X contributes to a conversation (e.g., at block 402), and is defined as a dominant emotional thinker (e.g., at lock 312), then a dominant quadrant A thinker may be invited to the conversation, or a user from any other quadrant, e.g., a quadrant different from the User X and/or the same as the User X to facilitate the generation of complementary and opposing conversations and ideas. If User X is also a top idea generator based on User X's innovation perspective profile, then a user that is a quadrant A thinker that is also an Innovation Supporter, Scout, or Originator may also be invited. Different weightings may be provided based on the overall innovation perspectives that may exist at the time. Dynamic matching between various innovation perspectives and personality assessment profiles may be performed in certain embodiments herein.

Block 416 is illustrated for convenience to represent the contribution from User X above, at block 402. A different user (e.g., User Y) may represent a user who may or may not have been invited to a conversation based on the contribution from User X at block 416.

At block 416, processing may continue to determine other users to dynamically invite to a conversation. For example, contributions from a user may be received and stored in a data store, such as a database. Additionally, a user's profile may be evaluated to determine the user's innovation perspective and thinking or personality perspective scores and the user's innovation perspective score and/or personality perspective score may be updated. For example, based on the user's behavior defined in creating the innovation perspective profile handlers (e.g., block 306 in FIG. 3), the innovation perspective may be updated to reflect the user's profile activity, which may affect the weighting of the user's contributions to conversations related to the activity.

Processing may continue in this manner until each user profile existing on the conversation management server 110 is analyzed to determine whether the user associated with the profile should be invited to a conversation.

At block 422, profiles (e.g., the innovation perspective profile and the personality perspective profile) of a user who made a contribution may be evaluated in part by accessing scores associated with each of the profiles. Such a process may be comparative in the way that it may analyze the overall perspective in relation to both the innovation perspective and the personality perspective as defined in block 306, 310, and 312, in one embodiment.

At block 418, the user's contribution may be stored in a database or other data store mechanism. Such a data store mechanism may be accessible to the conversation management server 110 such that the server 110 may access, analyze, and update information based on the contributions.

At block 420, a user's innovation perspective may be updated based on the contribution made by the user. Such an update may include updating both the user's customer innovation perspective score, as well as the global community's innovation perspective score.

Block 428 may be defined as a decision tree that determines if the contribution was based on a previous contribution (e.g., at block 402) and updates a user's, e.g., User X's innovation perspective (e.g., at block 408). Such an update may have an impact on the overall global communities' innovation perspective, as well as the user's own unique innovation perspective (e.g., at block 420).

At block 424, other users may be dynamically invited to contribute to a conversation string, e.g., a conversation string started by a user at block 402. Users may be invited to contribute to a conversation based on a user's contribution and updated innovation perspective score. An example of such activities is described in association with block 412.

No effect on User X, at block 426, may be defined as a decision tree method and/or function that determines whether the contribution from User Y (e.g., at block 414) is based on the contribution of User X (e.g., at block 402). If the contribution from User Y is not based on the contribution of User X, then User X's innovation perspective profile may not be impacted or changed. User Y's innovation perspective profile, however, may be impacted or changed.

FIG. 5 depicts a flow diagram of an example process that enables a user to select certain other users to participate in conversations with the user based on the innovation perspective profile and personality preference profile of the other users, according to an embodiment of the disclosure.

At block 502, a user, such as an administrative user with authority to perform various functions that other, non-administrative users may not perform, may create a new innovation session, conversation, or event. At block 503, the user may define a new session. The conversation management server 110 may creating the new session, conversation, or event in which a user has the ability to register, access the user's profile information (e.g., innovation preference profile and/or personality preference profile) and/or the conversation management server 110, and make contributions (e.g., as described in block 402 in FIG. 4).

A determination may be made at block 504 as to whether the new session was created. If the new session was created, a user may have the ability to register, access the user's profile information and/or the conversation management server, make contributions. If a new session was not created, a user may be unable to perform such functions. At block 505, a user may be presented with various options or choices that may make up innovation perspective profiles and thinking or personality preference profile information.

At block 506, the user, upon successfully defining a new session as validated by the conversation management server, may be presented with an option to selectively invite one or more users to the session based on the users' innovation perspective and/or thinking or personality assessment profiles. For example, a user may invite 10 Top Idea Generators, 200 Originators, 200 Supporters, and 100 Scouts to a given conversation, for example, to ensure a good mix of innovation perspectives. Of these users, the user who created the session may also invite users of specific thinking methods. In this case HBDI, 100 A quadrant, 100 B quadrant, 100 C quadrant, and 50 D quadrant users. This may facilitate a user's mix of thinking or personality perspectives user profiles as well as innovation perspectives, for example, to ensure top innovation achievement.

At block 508, regardless of whether the user with appropriate system level permissions invited specific users based on their innovation perspective and/or their thinking or personality assessment profiles, a new session may be started, at block 508. New session starting may represent the process in which a new conversation, session, and/or event is started. Such starting may drive innovation within a network of users via the conversation management server 110.

FIG. 6 depicts an example graphical user interface 600 for a user to create, submit, and view conversations, according to an embodiment of the disclosure. A user may enter text into a text-box item 610 and post the text for viewing by users by selecting the submit button. A user may navigate through one or more displays or interfaces on the user interface 600 by utilizing a panel 620 on the left portion of the user interface 600. Posted conversations may be displayed near the bottom portion of the user interface 600, in one embodiment. An example posted conversation 630 is shown in FIG. 6.

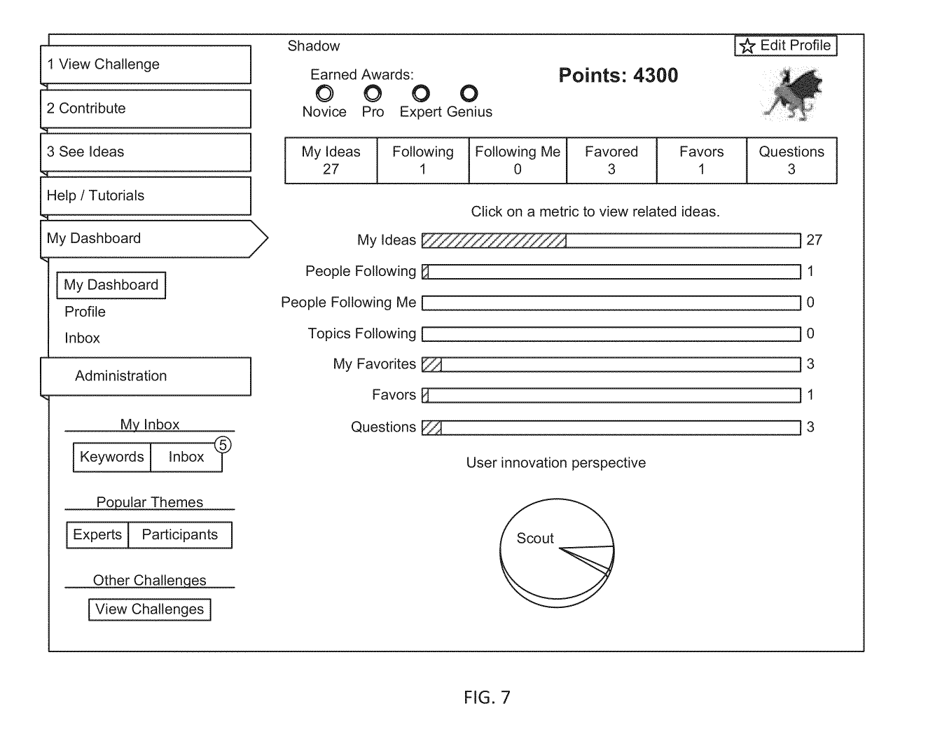

FIG. 7 illustrates an example dashboard representation of ideas generated by various users, according to an embodiment of the disclosure. As shown in FIG. 7, bar charts and pie charts may be utilized to portray ideas generated by question, ideas generated by day, and ideas generated by user. Various other information may be displayed in other examples.

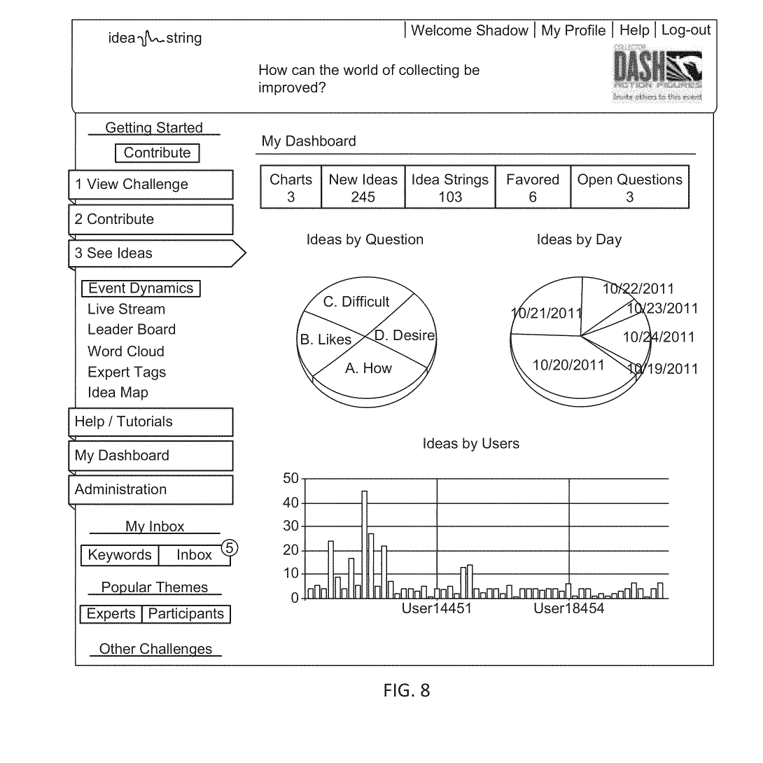

FIG. 8 illustrates an example dashboard representation of a user's innovation perspective, including points earned for idea generation, according to an embodiment of the disclosure. A user may click on certain metrics to view ideas related to the selected metric. A user may also view a point total to determine how many points a user has received, for example, in association with an idea generated by a user. Such a point total may influence a user's profile scores.

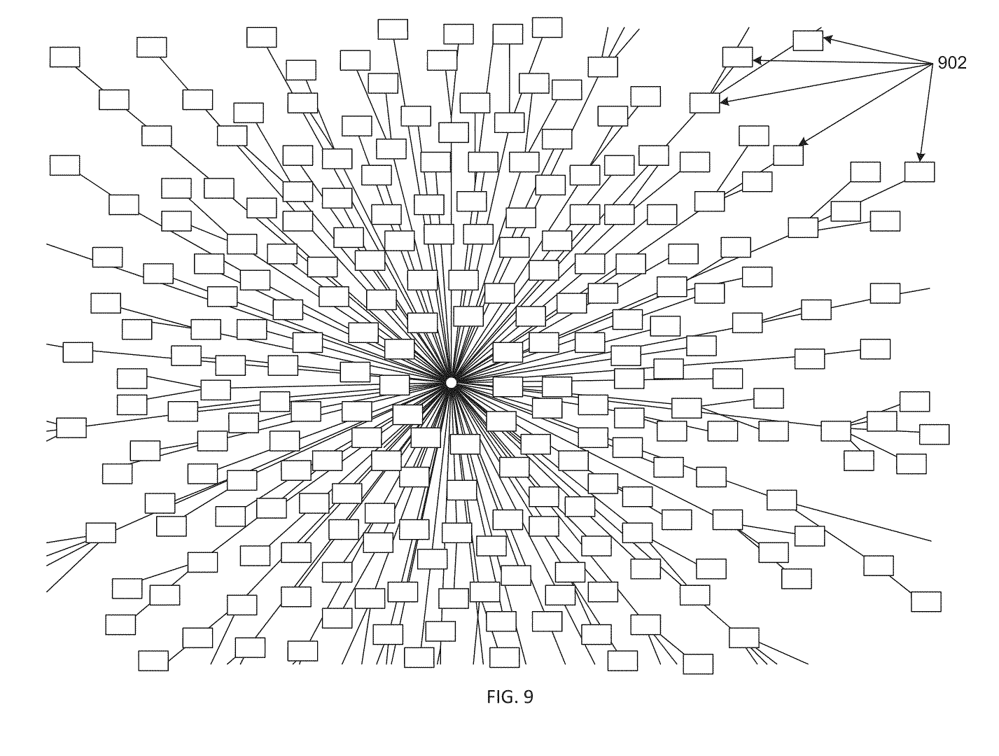

FIG. 9 illustrates an example display diagram depicting nodes representing conversations that have been associated with one another, according to an embodiment of the disclosure. Each conversation captured by the conversation management server, for example, may represent a node in a network. Conversations (or nodes) that are associated or linked with other conversations, e.g., by virtue of analyzing a user's profile information, may be represented as linked or associated in FIG. 9 via lines connecting nodes to one another. A line that intersects or contacts two or more nodes may indicate that the nodes or conversations have been joined or associated. Nodes may have multiple associations, or other nodes connected to the node, also as shown in FIG. 9. Such an association may indicate that the node has multiple conversations that were associated or joined by the conversation management server 110.

In some embodiments, all or a portion of the functionality described herein may be performed by one or more software programs and/or modules. For example, software, such as an operating system or software application, may configure itself without communicating with a configuration agent as described above.

The operations and processes described and shown above may be carried out or performed in any suitable order as desired in various implementations. Additionally, in certain implementations, at least a portion of the operations may be carried out in parallel. Furthermore, in certain implementations, less than or more than the operations described above may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable code or program instructions. Likewise, some blocks of the block diagrams and flow diagrams may not necessarily need to be performed in the order presented, or may not necessarily need to be performed at all, according to some implementations.

These computer-executable code or program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method comprising:
generating, by a management server comprising one or more computing devices, one or more profiles associated with one or more respective users, wherein the one or more profiles comprise a respective score;
receiving, at the management server, a contribution to a conversation from a user of the one or more respective users;
identifying, by the management server, at least a portion of the one or more respective users for participation in the conversation based at least in part on the contribution;
in response to the identification, sending a request from the management server to the at least a portion to participate in the conversation;
receiving, at the management server, one or more respective contributions from at least a portion of the one or more respective users; and
updating, by the management server, the respective score associated with a profile of the user based at least in part on the one or more respective contributions.

2. The method of claim 1, wherein the one or more profiles are based in part on at least one of the user's historical interaction with content on a web page or one or more scores associated with the user's personality assessment.

3. The method of claim 2, wherein the personality assessment is based at least in part on at least one of Birkman, Hermann Brain Dominance Instrument (HBDI), or Myers Brigg.

4. The method of claim 1, wherein the contribution is a message posted to a web site accessible by the one or more respective users.

5. The method of claim 1, wherein the one or more profiles comprise information associated with at least one of a number of ideas generated by the user or an amount of time the user spent accessing one or more web pages.

6. The method of claim 1, wherein the one or more profiles is determined based at least in part on one or more responses to a personality assessment test received from the user.

7. The method of claim 1, wherein the identification of the contribution is based at least in part on at least one of the user's job title, job function, domain expertise, or the number of years employed.

8. The method of claim 1, further comprising identifying the one or more users for participation based at least in part on a comparison between one or more respective profiles associated with the one or more users and the profile associated with the user.

9. The method of claim 8, wherein a first portion of the one or more respective profiles are complementary to the profile associated with the user and at least a second portion of the one or more respective profiles are opposing to the profile associated with the user.

10. A system comprising:
at least one memory that stores computer-executable instructions; and
at least one processor configured to access the at least one memory, wherein the at least one processor is configured to execute the computer-executable instructions to:
generate one or more profiles associated with one or more respective users, wherein the one or more profiles comprise a respective score;
receive a contribution to a conversation from a user of the one or more respective users;
identify at least a portion of the one or more respective users for participation in the conversation based at least in part on the contribution;
in response to the identification, send a request to the at least a portion to participate in the conversation;
receive one or more respective contributions from at least a portion of the one or more respective users; and
update the respective score associated with a profile of the user based at least in part on the one or more respective contributions.

11. The system of claim 10, wherein the one or more profiles are based in part on at least one of the user's historical interaction with content on a web page or one or more scores associated with the user's personality assessment.

12. The system of claim 11, wherein the personality assessment is based at least in part on at least one of Birkman, Hermann Brain Dominance Instrument (HBDI), or Myers Brigg.

13. The system of claim 10, wherein the contribution is a message posted to a web site accessible by the one or more respective users.

14. The system of claim 10, wherein the one or more profiles comprise information associated with at least one of a number of ideas generated by the user or an amount of time the user spent accessing one or more web pages.

15. The system of claim 10, wherein the one or more profiles is determined based at least in part on one or more responses to a personality assessment test received from the user.

16. The system of claim 10, wherein the identification of the contribution is based at least in part on at least one of the user's job title, job function, domain expertise, or the number of years employed.

17. The system of claim 10, the at least one processor further configured to identify the one or more users for participation based at least in part on a comparison between one or more respective profiles associated with the one or more users and the profile associated with the user.
